(19) United States
(12) Patent Application Publication
(10) Pub. No.: US 2007/0168408 A1
(43) Pub. Date: Jul. 19, 2007

(54) Parallel system and method for acceleration of multiple channel LMS based algorithms

(75) Inventors: Nick Skelton, Stockholm (SE); Harald Bergh, Ronninge (SE); Dake Liu, Linkoping (SE); Tommy Eriksson, Hagersten (SE); Niklas Persson, Solna (SE); Stig Stuns, Sundsvall (SE)

Correspondence Address: NORMAN H. ZIVIN;Cooper & Dunham LLP, 1185 Avenue of the Americas, New York, NY, 10036, US

(73) Assignee: Via Technologies, Inc.

(21) Appl. No.: 11/332,750

(22) Filed: Jan. 13, 2006

(51) Int. Cl. G06F 17/10

(52) U.S. Cl. 708/322

(57) ABSTRACT

A parallel system for performing LMS coefficient adaptation includes a data memory, a tap memory, and two or more LMS hardware units. The LMS hardware units utilize data stored in the data memory and coefficients stored in the tap memory for performing multiple LMS coefficient adaptations in parallel.

### BACKGROUND

1. Technical Field

The present disclosure relates to LMS based algorithms and, more specifically, to parallel architecture for acceleration of multiple channel LMS based algorithms.

2. Description Of the Related Art

An electronic filter is a device for eliminating unwanted frequencies from an electronic signal. Digital filters are electronic filters that are capable of filtering digital signals, for example, analog signals that have been converted into digital signals, for example, using an analog-to-digital converter.

One example of a digital filter is a line echo cancellation filter. The line echo cancellation filter attempts to reduce echo from digitally communicated audio signals. For example, line echo cancellation filters may be applied to multiple channels of telephone lines to reduce echo from the telephone lines.

Some digital filters, for example, some line echo cancellation filters, may be adaptive filters. Adaptive filters are digital filters that can analyze the filter output and use it to modify the filtering technique (e.g. the filter coefficients) to improve the digital filter quality in real-time. Adaptive filters may use feedback to refine the values of the filter coefficients and hence modify the adaptive filter's frequency responses.

Adaptive filters may refine the filter coefficients by analyzing multiple digital signals in an attempt to isolate the unwanted noise signals that may be present in the multiple digital signals.

Adaptive filters, as well as other digital filters, may utilize least mean square (LMS) algorithms in computing digital filter operations. LMS algorithms are optimization techniques that attempt to find a “best fit” to a set of data by attempting to minimize the sum of the squares of the difference (called residuals) between the fitted function and the data.

Line echo'cancellation filters are often implemented using digital signal processors (DSPs). DSPs are special-purpose microprocessors that have been optimized for the processing of digital signals. When using a DSP to implement digital filters, for example, line echo cancellation filters, it is ideal to maximize efficiency by reducing the number of cycles necessary to accomplish calculations and by minimizing the use of available memory. By increasing efficiency, a single DSP may be able to perform line echo cancellation on multiple line channels at the same time. Additionally, increasing efficiency may allow a single DSP to support multiple line channels using a limited amount of available memory with time division multiplexing (TDM). This is because TDM is commonly used to time-share available memory among multiple line channels. TDM therefore results in a lower memory cost per channel as system speed goes up or time used per channel goes down. Therefore increased DSP efficiency for handling digital filtering, for example, multi channel line echo cancellation, can lead to reduced implementation costs.

Embodiments of the present invention therefore seek to increase the efficiency for processing LMS algorithms, for example, to increase the efficiency by which DSPs can perform multiple channel line echo cancellation.

### SUMMARY

A parallel system for performing LMS coefficient adaptation includes a data memory, a tap memory, and two or more LMS hardware units. The LMS hardware units utilize data stored in the data memory and coefficients stored in the tap memory for performing multiple LMS coefficient adaptations in parallel.

A method for performing LMS coefficient adaptation using parallel architecture includes storing data in a data memory of the parallel architecture, storing coefficients in a tap memory of the parallel architecture, and performing multiple LMS coefficient adaptations. The multiple LMS coefficient adaptations are performed from the data stored in the data memory and the coefficients stored in the tap memory using two or more LMS hardware units, of the parallel architecture, in parallel.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram showing hardware for accelerating multiple channel line echo cancellation according to an embodiment of the present invention;

FIG. 2 is a chart illustrating how LMS computations may be performed during the initial phase of the pipeline according to an embodiment of the present invention;

FIG. 3 is a chart illustrating how LMS computations may be performed during the finishing phase of the pipeline according to an embodiment of the present invention; and

FIG. 4 is a chart illustrating a method for simultaneously reading and writing to and from tap memory according to an embodiment of the present invention.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present invention seek to utilize multiple LMS computing units for calculating multiple LMS filter taps in parallel so that LMS filter calculation performance may be enhanced. By enhancing the efficiency of LMS computations, digital filtering, for example, multiple channel line echo cancellation, may be performed more quickly. Additionally, a single DSP supporting more channels may provide for more efficient usage of the available DSP memory.

Embodiments of the present invention also seek to use double-width single-port memory, so that Tap Memory (TM) can seemingly be both read and written to at the same time without requiring a two-port memory. This may provide an advantage as single-port memory may be more power efficient than two-port memory.

Moreover, by calculating multiple taps in parallel using a single filter with multiple LMS units, a single large Data Memory (DM) and a single large double-width Tap Memory may be used. this is advantageous over using multiple single-channel LMS processors as using a single large memory uses less space than multiple smaller memories.

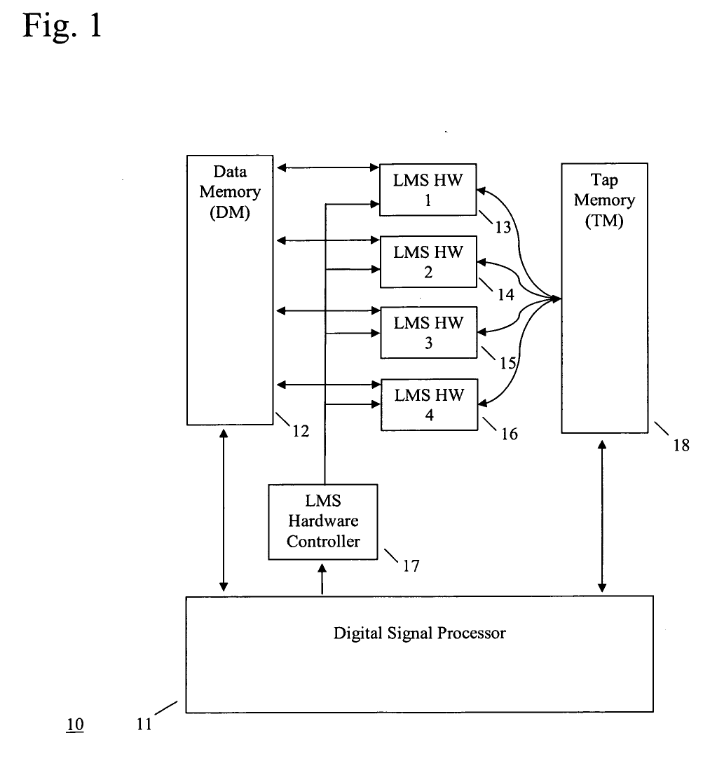

FIG. 1 is a block diagram showing hardware for accelerating digital filtering, for example, using multiple channel line echo cancellation, according to an embodiment of the present invention. The hardware 10 may comprise a processor, for example a DSP 11 for processing digital signals. The DSP 11 may be connected to data memory 12. Data memory 12 may be internal program memory utilized by the DSP 11. The DSP 11 may also be connected to an LMS hardware controller 17. The LMS controller 17 may be capable of receiving instructions and parameters from the DSP 11 and delegating LMS processing tasks, for example kernel operations for the LMS algorithms, to multiple LMS hardware units 13-16. Parameters may include a convergence factor for coefficient adaptation. The convergence factor may be a function representing how similar the output signal is to the desired response, wherein the output signal is equal to the desired response plus the error signal, as shown by the equation:

ti y(n)=d(n)+e(n)

Wherein y(n) represents the output signal, d(n) represents the desired response signal and e(n) represents the error signal. Additional parameters may include the filter length (which means number of filter coefficient), a top and bottom position of a circulation data buffer in the data memory 12, a data starting point in the data memory 12, and the coefficient starting point in the tap memory 18.

The multiple LMS hardware units 13-16 may be connected in parallel to the LMS controller 17 such that any of the multiple LMS hardware units 13-16 may receive LMS processing tasks from and return results to the LMS controller 17. The hardware 10 may comprise any number of LMS hardware units 13-16. For example, the hardware 10 may comprise 4 LMS hardware units 13-16 as shown in FIG. 1. However, according to other embodiments of the present invention, the hardware 10 may comprise more than 4 LMS hardware units 13-16 for additional LMS processing power. According to other embodiments of the present invention, the hardware 10 may have fewer than 4 LMS hardware units 13-16. For example, the hardware 10 may have 1, 2 or 3 LMS hardware units 13-16.

Each LMS hardware unit 13-16 may be comprised of a multiply-add component for coefficient adaptation and a multiplication and accumulation unit for convolution, as adaptation and convolution may be useful for LMS computation.

The LMS hardware units 13-16 may be connected, for example in parallel, to a Tap Memory (TM) 18. The tap memory 18 may be used by the LMS hardware units 13-16 for storing coefficients (taps) used in LMS computation. The tap memory 18 may support reading old tap and writing new tap in a single clock cycle. This may be accomplished using either dual-port SRAM (SRAM allowing for simultaneous read and write). Alternatively, single port SRAM may be used, for example using techniques described in U.S. Pat. No. 6,714,956 to Liu et al., which is incorporated by reference. Alternatively, a double-width single-port memory may be used so that the Tap Memory can seemingly be both read from and written to at the same time without requiring dual-port memory.

According to embodiments of the present disclosure, the DSP may have read and write access to the data memory and the tap memory. The DSP may not access the data memory or the tap memory at the same time as the LMS HW units. The width of the data memory may be 4×the word length of the data samples. The number of words in the data memory may be n/4 where n is the length of the filter.

According to embodiments of the present invention using 2-port memory, the width of the tap memory may be 4×the word length of the filter coefficients (taps). The number of words in the tap memory may be n/4.

According to embodiments of the present invention using single port memory, the tap memory size may be 8×the word length of the filter coefficients. The number of words in the tap memory may be n/8.

For example, in the case of 4 LMS HW units, to be able to read 4 data samples during the same clock cycle, the width of the data memory is required to be 4 times the width of the data samples. When using a 2-port memory for the tap memory, the tap memory size requirements are the same as the data memory. When using a single port memory for the tap memory, the tap memory width must be 2 times the data memory width (to allow for double width reads and writes).

Although the present invention apparently requires wider memories, an implementation may decide to divide these wide memories into several narrower memories. The reason to do this is so that the memory width could match the word length of the DSP, which will make it easier to map the data memory and tap memory into the DSP's memory address map.

The DSP may load parameters into the LMS HW controller. The DSP may load a frame of data into the data memory, and the initial filter coefficients values into the tap memory. The LMS HW units may perform the LMS calculations. During the LMS calculations, the filter coefficients may be adapted and new values written to the tap memory. The accumulated result of the LMS filter calculation may be written to data memory, where it may be read by the DSP. The DSP may read the tap memory and save the filter coefficients for the current channel.

These steps may be repeated for as many channels as possible that may be calculated within the available sample rate according to principals of TDM (time division multiplexing). In this way, as many channels as possible may be supported while minimizing hardware and memory requirements. The number of channels that may be filtered may depend on the filter length, the sampling rate, and the clock frequency of the hardware.

In performing digital signal filtering such as line echo cancellation filtering, convolution and coefficient adaptation must be performed a great number of times. By employing multiple LMS hardware units, multiple convolutions and coefficient adaptations may be performed in parallel thereby expediting the signal filtering. The LMS Hardware Controller 17 distributes convolution and coefficient adaptation assignments to the various LMS hardware units 13-16.

Each LMS hardware unit may then perform the assigned convolution and coefficient adaptation. The adapted coefficients may then be written back into the Tap Memory.

A single convolution and coefficient adaptation assignment may be broken down into several steps. First, a data sample may be read from the data memory. Then coefficients may be read from the tap memory. Next, coefficient adaptation may be performed. Finally, convolution may be performed and the adapted coefficients may be written back into tap memory.

The LMS hardware units may perform these several steps in a pipeline. In this pipeline, each LMS hardware unit may be responsible for completing a single step during each clock cycle. For example, during one clock cycle, a first LMS hardware unit may be responsible for reading a data sample from the data memory and for reading coefficients from the tap memory. A second hardware unit may then be responsible for performing coefficient adaptation. A third hardware unit may then be responsible for performing convolution. A fourth hardware unit may then be responsible for writing the adapted coefficients back into the tap memory.

The width of the memory may determine the number of LMS hardware units that may be supported. The number of pipeline stages may indirectly affect the number of LMS hardware units that may be supported.

The pipeline maximizes efficiency by not having to wait until one convolution and coefficient adaptation process is completed before beginning the next. For example, the first LMS hardware unit may read a data sample from the data memory and read coefficients from the tap memory for a first coefficient adaptation process, then read a data sample from the data memory and read tap coefficients from the tap memory for the next coefficient adaptation process as the second LMS hardware unit performs adaptation for the first coefficient adaptation process, and so on.

Each LMS hardware unit may perform assignments for multiple coefficient adaptation processes at the same time. For example, the first LMS hardware unit may read data samples from the data memory and read tap coefficients from the tap memory for a set of four coefficient adaptation processes in a single clock cycle.

As the pipeline gets started (the initial phase) all LMS hardware units will not be functioning until the first set of coefficient adaptation process makes its way down the pipeline. After that, all LMS hardware units may be functioning in parallel (normal iteration phase). During the normal iteration phase of the pipeline, as many coefficient adaptation processes may be performed in a single clock cycle as there are coefficient adaptation processes in a set. For example, where there are four coefficient adaptation processes in a set, four coefficient adaptation processes may be completed in a single clock cycle.

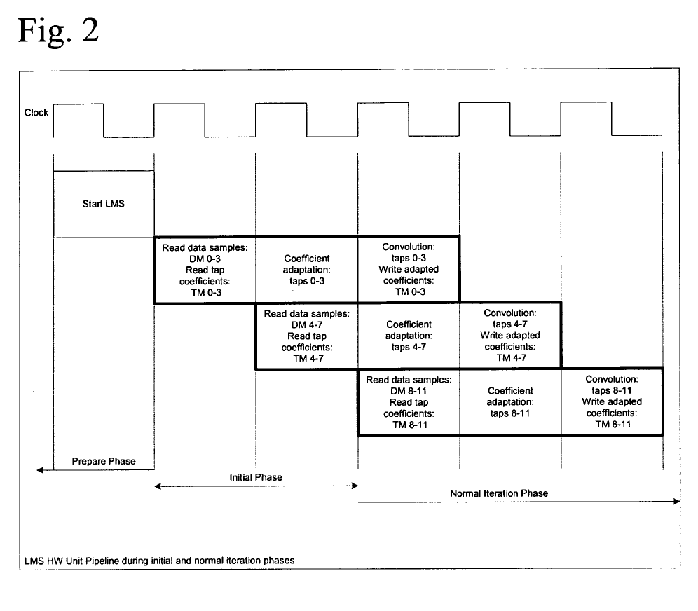

FIG. 2 is a chart illustrating how LMS computations may be performed during the initial phase of the pipeline according to an embodiment of the present invention. The top of the chart shows a square wave labeled “Clock” representing the clock cycle, where each complete period of the square wave represents a full clock cycle. At the first clock cycle, the LMS is started. This step may be considered the prepare phase. At the second clock cycle, the initial phase may begin as 4 units of data (numbered as 0-3) may be fetched from the data memory (DM) and 4 coefficients (numbered as 0-3) may be fetched from the tap memory (TM). At the next clock cycle, adaptation is performed using the 4 units of data and 4 coefficients previously read (coefficient adoption: taps 0-3). Also at this clock cycle, 4 more units of data (numbered 4-7) may be fetched (read) from the data memory and 4 more coefficients (numbered to as 4-7) may be fetched from the tap memory. At the next clock cycle, the normal iteration phase may begin as data fetching, coefficient fetching, adaptation and convolution may all be performed in a single clock cycle as convolution is performed on 0-3, adapted coefficients 0-3 are written, adaptation is performed on 4-7, data fetching is performed for DM 8-11, and tap coefficients TM 8-11 are read. Cycles may continue in this way until the last of the data has been convoluted and written. At this point a finishing phase may be entered as current processes make their way through the pipeline without new processes are entering the pipeline.

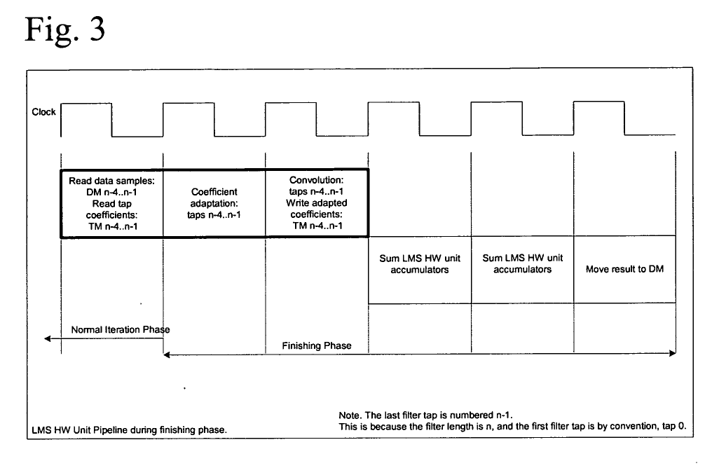

FIG. 3 is a chart illustrating how LMS computations may be performed during the finishing phase of the pipeline according to an embodiment of the present invention. Here, n is the number of data/coefficients used in the LMS computations, i.e. there are n data/coefficients numbered 0 through n−1. At the conclusion of the normal iteration phase, the final 4 (numbered as n−4 ... n−1) units of data memory are fetched and the final 4 coefficients (TM n−4...n−1) are fetched. At the next clock cycle (the first clock cycle of the finishing phase), adaptation is performed using the final 4 units of data and the final 4 coefficients. In the next clock cycle, convolution may then be performed for the final 4 adapted taps followed by adaptation, including the writing (write) back of the adapted coefficients TM n−4...n−1 to the tap memory. At the next two clock cycles, accumulation registers of the LMS used during LMS calculations may be summed up. At the next clock cycle, the result may be moved to DM,

For example, coefficients (t) may be adapted according to the following expression:
t_{new}(n)=t_{old}(n)+ConvergenceFactor* x(n)
ACC=ACC+x(n)*t_{new}(n)

Where t_{new}(n) is the adapted coefficient, t_{old}(n) is the previously used coefficient, x(n) is data in the circulation buffer. The ACC is the accumulation register for convolution.

For example, accumulation registers may be summed up according to the following expressions:
ACC₁=ACC₁+ACC₂
ACC₃=ACC₃+ACC₄

Then, accumulation registers may be summed up according to the following expression:
ACC₁=Saturation{Round[ACC₁+ACC₃]}

The values for ACC₁ and ACC₃ that were summed may be combined and rounded. Saturation may then be provided, where needed, to prevent the accumulation registers from taking a value greater than the maximum possible value. The accumulator register may be moved to data memory and made available to the DSP and/or the LMS accelerator controller.

Embodiments of the present invention may utilize dual port SRAM at tap memory. Alternatively single port SRAM may be used. When using single port SRAM, a method for simultaneously reading and writing to and from tap memory may be used. For example, the method for reading and writing to and from tap memory using even-odd memory described in Liu et al. may be used. Alternatively, a method for simultaneously reading and writing to and from tap memory based on double width read during odd clock cycles and double width write during even clock cycles may be used.

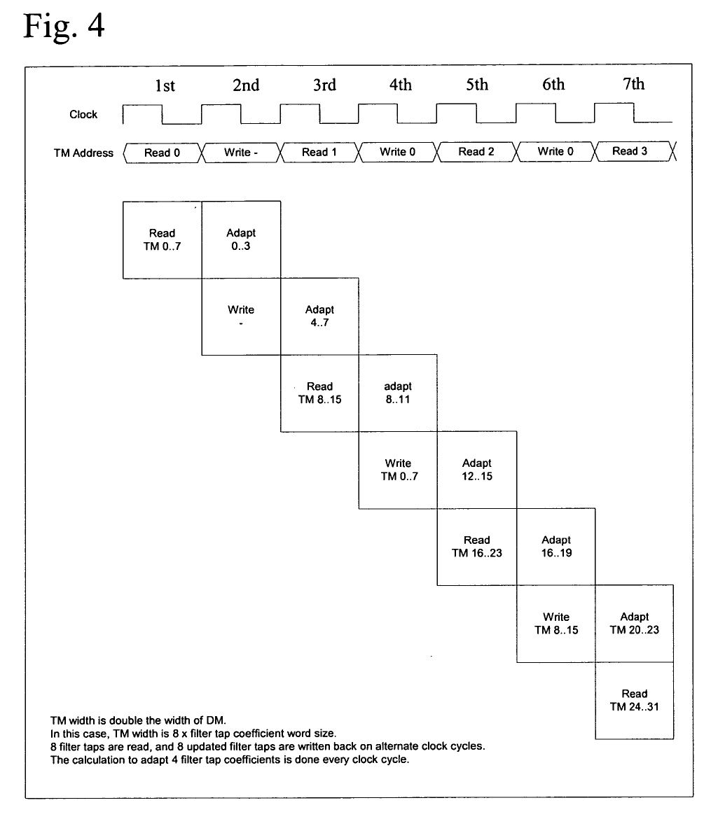

FIG. 4 is a chart illustrating a method for simultaneously reading and writing to and from tap memory according to an embodiment of the present invention. This method may be applied to the embodiments of the present invention disclosed above. This method allows for an embodiment of the present invention where memory may not be read from and written to during the same clock cycle. According to this embodiment, at the first clock cycle, a first double read may be conducted, for example, 8 coefficients (TM 0..7) may be retrieved. At the second clock cycle, adaptation of the first half (0..3) of the first double read may be performed. No write operations need to be performed at the second clock cycle (write -). At the third clock cycle, adaptation of the second half (4 . . . 7) of the first double read may be performed. Also at the third clock cycle, the next double read may occur (TM 8 . . . 15). At the fourth clock cycle, adaptation of the first half (8 . . . 11) of the second double read may occur. Also at the fourth clock cycle, the writing of the adaptation of the first double read (TM 0 . . . 7) may occur. At the fifth clock cycle, adaptation of the second half of the second double read (12 . . . 15) may occur. Also at the fifth clock cycle, the reading of the third double read (TM 16 . . . 23) may occur. At the sixth clock cycle, adaptation of the first half (16 . . . 19) of the third double read may occur. Also at the sixth clock cycle, the writing of the adaptation of the second double read (TM 8 . . . 15) may occur. At the seventh clock cycle, adaptation of the second half (20 . . . 23) of the third double read may occur. Also at the seventh clock cycle, the reading of the fourth double read (TM 24 . . . 31) may occur. This pattern may be repeated until all data is read, adapted and written.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A parallel system for performing LMS coefficient adaptation, comprising:
a data memory;
a tap memory; and
two or more LMS hardware units for utilizing data stored in the data memory and coefficients stored in the tap memory for performing multiple LMS coefficient adaptations in parallel.

2. The parallel system of claim 1, wherein the LMS coefficient adaptations are performed for adaptive filtering.

3. The parallel system of claim 1, further comprising a digital signal processor, in communication with the data memory, the tap memory and the two or more LMS hardware units.

4. The parallel system of claim 3, wherein the digital signal processor loads a frame of data into the data memory and initial filter coefficients values into the tap memory.

5. The parallel system of claim 3, further comprising an LMS controller, the LMS controller is capable of receiving instructions and parameters from the digital signal processor and delegating LMS processing tasks to multiple LMS hardware units.

6. The parallel system of claim 3, further comprising an LMS controller, in communication with the digital signal processor, for controlling the two or more LMS hardware units.

7. The parallel system of claim 6, wherein the two or more LMS hardware units are connected in parallel to the LMS controller such that any of the multiple LMS hardware units receives LMS processing tasks from and return results to the LMS controller.

8. The parallel system of claim 1, wherein the LMS hardware units are connected in parallel to the tap memory.

9. The parallel system of claim 1, wherein the coefficient adaptation and a convolution are used in a LMS calculation, each LMS hardware unit is comprised of a multiply-add component for the coefficient adaptation and a multiplication and accumulation unit for the convolution.

10. The parallel system of claim 9, wherein the LMS hardware units perform the LMS calculation, during the LMS calculation, the filter coefficients are adapted and new values are written to the tap memory, and an accumulated result of the LMS calculation is written to the data memory.

11. The parallel system of claim 1, wherein the LMS hardware units perform reading a data sample from the data memory and reading the coefficients from the tap memory, performing coefficient adaptation, performing convolution, and writing the adapted coefficients back into the tap memory in a pipeline.

12. The parallel system of claim 1, wherein each LMS hardware unit is responsible for completing a single step during each clock cycle.

13. The parallel system of claim 1, wherein each LMS hardware unit performs multiple coefficient adaptation processes at the same time.

14. The parallel system of claim 1, wherein the tap memory is a double-width single-port memory allowing for reading and writing in the same clock cycle.

15. The parallel system of claim 1, wherein the tap memory is a dual-port memory allowing for reading and writing in the same clock cycle.

16. A method for-performing LMS coefficient adaptation using parallel architecture, comprising:
storing data in a data memory of the parallel architecture;
storing coefficients in a tap memory of the parallel architecture; and
performing multiple LMS coefficient adaptations from the data stored in the data memory and the coefficients stored in the tap memory using two or more LMS hardware units, of the parallel architecture, in parallel.

17. The method of claim 16, wherein the LMS coefficient adaptations are performed for adaptive filtering.

18. The method of claim 16, wherein the LMS hardware units are connected in parallel to the tap memory.

19. The method of claim 16, further comprising: reading a data sample from the data memory and reading the coefficients from the tap memory, performing coefficient adaptation, performing convolution, and writing the adapted coefficients back into the tap memory in a pipeline.

20. The method of claim 16, wherein each LMS hardware unit is responsible for completing a single step during each clock cycle..

21. The method of claim 16, wherein each LMS hardware unit performs multiple coefficient adaptation processes at the same time.

22. The method of claim 16, wherein the tap memory is a double-width single-port memory and reading and writing are performed in the same clock cycle.

23. The method of claim 16, wherein the tap memory is a dual-port memory allowing for the reading and writing to be performed in the same clock cycle.
